(19) United States
(12) Patent Application Publication
(10) Pub. No.: US 2010/0196570 A1
(43) Pub. Date: Aug. 5, 2010

(54) Spent Grain Bunker

(76) Inventors: Kurt Stippler, Marzling (DE); Klaus-Karl Wasmuht, Ellingen (DE); Cornelia Stumpe, Regensburg (DE); Heinz Humele, Thalmassing (DE)

Correspondence Address: MARSHALL, GERSTEIN & BORUN LLP, 233 SOUTH WACKER DRIVE, 6300 WILLIS TOWER, CHICAGO, IL, 60606-6357, US

(21) Appl. No.: 12/596,694

(22) PCT Filed: Apr. 3, 2008
(86) PCT No.: PCT/EP08/02671

§ 371 Date: Mar. 3, 2010

(30) Foreign Application Priority Data
Apr. 30, 2007 (EP) 07008788.7

(51) Int. Cl. C12C 7/14; C12C 7/17; C12C 7/00

(52) U.S. Cl. 426/489; 99/278

(57) ABSTRACT

The invention relates to a spent grain bunker and a purifying process, wherein the spent grain bunker comprises a housing and a delivery device located in a lower region of the housing, delivering the spent grain out of the spent grain bunker. In order to enable a greater brew cycle and heavily dewater the spent grain, which also can shorten the purifying time, at least one part of the housing is designed as a strainer surface in the lower region of the housing of the spent grain bunker. Thus, when draining the last sparge or drawing the final wort from the purifying tub, the spent grain can be removed into a spent grain bunker, and the remaining fluid can be extracted from the spent grain by a strainer surface in the spent grain bunker.

### CROSS-REFERENCE TO RELATED APPLICATION

The present application claims the benefit of priority of International Patent Application No. PCT/EP2008/002671, filed Apr. 3, 2008, which claims the benefit of European Patent Application No. 07008788.7, filed Apr. 30, 2007. The entire text of the priority application is incorporated herein by reference in its entirety.

### FIELD OF THE DISCLOSURE

The disclosure relates to a spent grain bunker as well as a lautering process to produce wort.

### BACKGROUND

After the malt has been bruised, mashing is the second process section of wort production in the brewing house. At the end of the mashing process, the mash consists of an aqueous mixture of dissolved and undissolved matter. The aqueous solution that contains the extraction matter is referred to as wort, the undissolved portions are referred to as spent grain. For beer production, only the wort is used and to this end must be separated from the spent grains as completely as possible. This separation process is referred to as lautering. Lautering is a filtration procedure where the spent grain assumes the role of the filter material. In a well-known manner, lautering is performed over a lauter tub in two phases, that means the draining of the first wort and the washing out of the spent grain (last wort) with the sparging water. After lautering, the wort is then supplied to the wort copper or a corresponding pre-run vessel for further processing. Such a lauter tub or such a lautering process, respectively, are generally known and for example illustrated in greater detail in “Technologie Brauer and Malzer”, Kunze, 8th edition 1989, VLB Berlin, p. 243-271. The technical terms used in this application are described more in detail therein.

The spent grain separated off in the lauter tub finally has to be removed from the lauter tub and disposed of. To ensure higher productivity, it is desirable to shorten the lauter time.

### SUMMARY OF THE DISCLOSURE

Starting from this, it is an aspect of the present disclosure to provide a method and a device that permit to shorten the lauter time, where greater brew cycles can be achieved as a consequence.

According to the present disclosure, a spent grain bunker for receiving spent grain from a lauter device, e.g. from a lauter tub, is designed such that at least one part of the housing is designed as a strainer surface in the lower region of the housing. Thus, the spent grain in the spent grain bunker which is not yet completely dewatered can be further dewatered. This offers the advantage that the spent grain can be even better dried without extending the lauter time in the lauter tub. By at least one part of the housing being embodied as a strainer surface in the lower region, the remaining fluid with more or less remaining extract, i.e. the last sparge quantity or the last wort, respectively, can be pumped off and discharged through the strainer surface. As the strainer surface is arranged in the lower portion of the housing, pumping off is facilitated as the remaining fluid flows down in the spent grain due to gravity. The strainer surface can be realized, for example, as punched plate, as slotted or milled false bottom, or as a wire kiln floor arrangement. Lower region here means a region that is situated in the lower half of the spent grain bunker. The fact that the strainer surface is embodied in the lower region means at least in the lower region.

It is particularly advantageous for the housing to be embodied essentially like a funnel at least in the lower region. Thus, the spent grain can be easily discharged from the spent grain bunker by the delivery device.

According to a preferred embodiment, at least one part of the side walls of the housing and/or at least one part of the front and rear walls is embodied as a strainer surface. The bottom of the housing can also either comprise several openings through which remaining fluid seeping through to the bottom can drain or be pumped off. The bottom can at least partially be embodied as a strainer surface, just like the side walls, to also efficiently dewater the spent grain from the bottom.

Advantageously, a tub is arranged externally at the strainer surface via which tub the remaining fluid can be drawn out of the spent grains. The tub can then end in a discharge via which the remaining fluid is pumped off by means of a pump. If several strainer surfaces are arranged in the housing, corresponding tubs or one mutual tub can be provided which then end in a discharge for the spent grain water. Underneath the strainer surface, a simple channel can also be arranged via which the remaining fluid then drains.

Advantageously, the delivery device is speed controlled. This offers the advantage that it e.g. according to a first embodiment does not work during dewatering or is only driven at a low performance, i.e. in case of a conveyor screw it only runs at a slow speed, so that the spent grain is loosened up by the delivery device. For the removal, the conveying capacity can be increased, where e.g. in case of a conveyor screw, the speed is increased so that a quick removal is possible. By changing the sense of rotation, loosening can be achieved without the spent grain being conveyed out of the bunker. For better loosening, a loosening device can also be provided above the delivery device which loosens up the spent grain.

Advantageously, the delivery device is a pressure worm that presses the remaining fluid out of the spent grain. Advantageously, the strainer surface is then arranged at the bottom of the housing as tubular strainer basket and has an opening directed upwards, the pressure worm running in the tubular strainer basket. Thus, the spent grain can fall into the strainer basket and the pressure worm via the opening, be pressed out and delivered out of the spent grain bunker. The spent grain can thus be optionally mechanically pressed out to achieve a water content of about 60%. The worm can in this case comprise means to control the pressing power or the pressing performance onto the spent grain. To this end, the worm can be speed or frequency controlled so that the performance can be adapted. To this end, alternatively or additionally, a controllable flow resistance can be provided at the end of the pressure worm.

According to a preferred embodiment, the pressure worm comprises a first section arranged in the lower region of the housing, and a second section extending laterally of the housing preferably diagonally upwards.

In a method according to the present disclosure, already towards the end of the last sparge or when the last wort is being drawn from the lauter device, e.g. the lauter tub, the spent grain is removed into a spent grain bunker, where in the spent grain bunker remaining fluid is extracted from the spent grain via a strainer surface. This means that after the end of the sparging process, i.e. after the end of the application of the complete quantity of sparging water during the draining of the last sparge, the spent grain door or the spent grain doors are opened and the spent grain is discharged into the spent grain bunker in a clearly moister state than before. It is also possible to already open the spent grain door(s) during the drawing of the last wort (i.e. when remaining fluid is drained off the lauter tub that comprises a low extract content and is not guided into the wort copper but for example into a last wort tank) and to remove the spent grain into the spent grain bunker. By performing the draining of the last sparge or the drawing of the last wort—in difference to the conventional lautering process—in parallel to the removal of the spent grain, or at least by overlapping these procedures—meaning that e.g. the last sparge has not yet completely drained or that the last wort has not been completely drawn during the removal of the spent grains, the lauter time can be clearly shortened so that greater brew cycles can be achieved. It is moreover possible to dry the spent grain even better than before, although the spent grain is discharged in a still clearly moist condition. By the dewatering of the spent grain in the spent grain bunker, the period for draining the last sparge or the period for drawing the last wort in the lauter tub can be greatly reduced.

The remaining fluid withdrawn in the spent grain bunker can be supplied to a tank, in particular a last wort tank, and then for example be used for sparging or as mashing water for the next brew. If the spent grain is already guided into the spent grain bunker during the draining of the last sparge and is dewatered there, so that the withdrawn remaining water is still rich in extracts, this can be also supplied to a pre-run vessel or a wort copper arranged downstream thereof. The dewatered compacted spent grain is then guided via a delivery device from the spent grain bunker for example to a spent grain silo.

The compacted spent in is, after remaining fluid has been extracted from it, discharged from the spent grain bunker via a delivery device. Advantageously, the delivery device is a pressure worm, so that the remaining fluid can be pressed out of the spent grain by the pressure worm. Thus, the delivery device can assume two functions, on the one hand pressing out the spent grain, and on the other hand discharging the pressed out spent grain. Advantageously, the pressing performance or the pressing power onto the spent grain can be controlled and thus adapted to different processes.

### BRIEF DESCRIPTION OF THE DRAWINGS

The present disclosure will be illustrated below in greater detail with reference to the following figures.

FIG. 1 roughly schematically shows a first embodiment of a spent grain bunker according to the present disclosure in a perspective representation.

FIG. 2 shows a cross-section through a second possible embodiment of a spent grain bunker according to the present disclosure.

FIG. 3 shows a lauter tub together with the spent grain bunker according to the disclosure.

FIG. 4 roughly schematically shows the spent grain bunker according to the disclosure together with the lauter tub, as well as the mash tub and the wort copper.

FIG. 5 shows a first possible embodiment of the method according to the disclosure.

FIG. 6 shows a second possible embodiment of the method according to the disclosure.

FIG. 7 shows a schematic view of a delivery device as well as a loosening device.

FIG. 8 schematically shows an extract content in response to time.

FIG. 9 roughly schematically shows a third embodiment according to the present disclosure in a perspective representation.

FIG. 10 roughly schematically shows a section along line II-II in FIG. 9 through the third embodiment.

FIG. 11 roughly schematically shows a section through the strainer basket according to a preferred embodiment.

### DETAILED DESCRIPTION OF THE PREFERRED EMBODIMENT

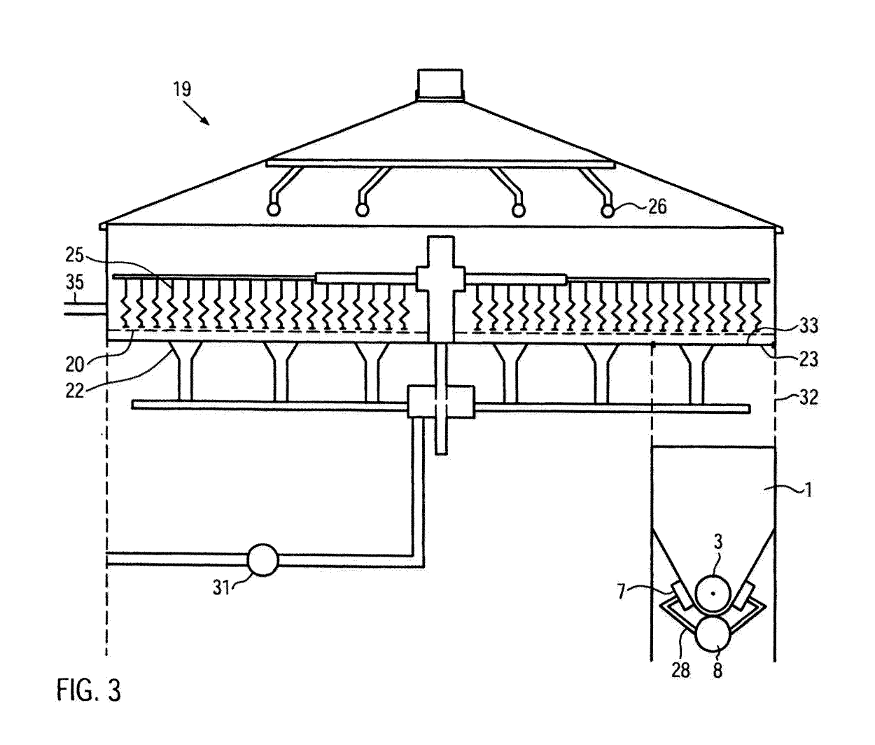

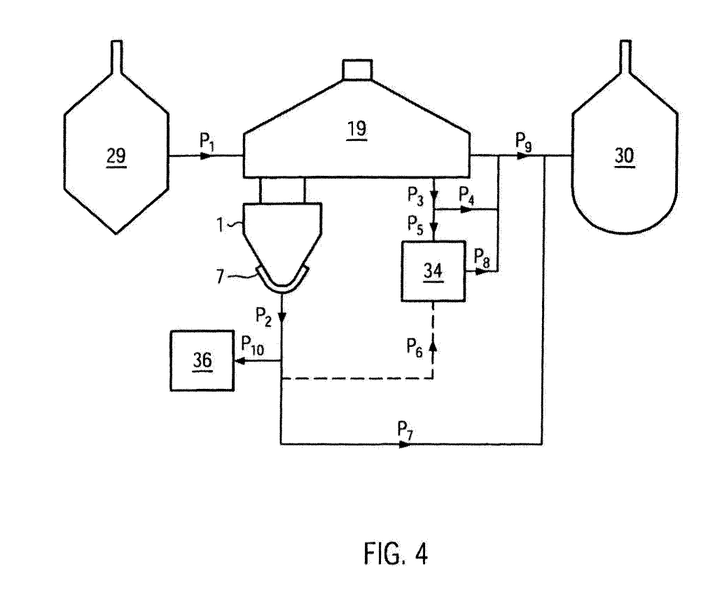

FIG. 3 roughly schematically shows a lauter tub. FIG. 3 is only one example of a possible lauter tub. The lauter tub 19 consists of a cylindrical vessel comprising a tub bottom 23 and a false bottom or a needle slot screen bottom 20, e.g. with slot widths within a range of 0.7 to about 1.5 mm and a free sieving area of up to 20%. The bottom can also comprise a slotted bottom with slots of for example 0.7 mm times 80 mm, and a free sieving area of up to 20%. Reference numeral 35 designates a mash admission. In a known manner, the lauter tub furthermore comprises hacking knives 25 as well as means such as e.g. nozzles 26 for supplying the sparging water. The spent grain remains lying on the false bottom 20 while the wort is draining through the false bottom and withdrawn through the lauter tulips (lauter cones) 22 via a tauter pump 31, and can be supplied to a pre-run vessel 34 or a wort copper 30 or a last wort tank 36 (see FIG. 4) in a well-known manner.

At least one spent grain bunker 1 is arranged underneath the lauter tub. The spent grain bunker 1 can, for example, be connected to the tub bottom 23 via the spent grain waste box 32, spent grain door(s) being provided in the lauter tub bottom 23 through which the spent grain can be removed. For this, in a well-known manner a non-depicted spent-grain removal rake is provided which is folded down and pushes the spent grain towards the spent grain door. It is also possible to lift the cutting knives and in the process orient the knives 25 transversely such that the spent grain is discharged.

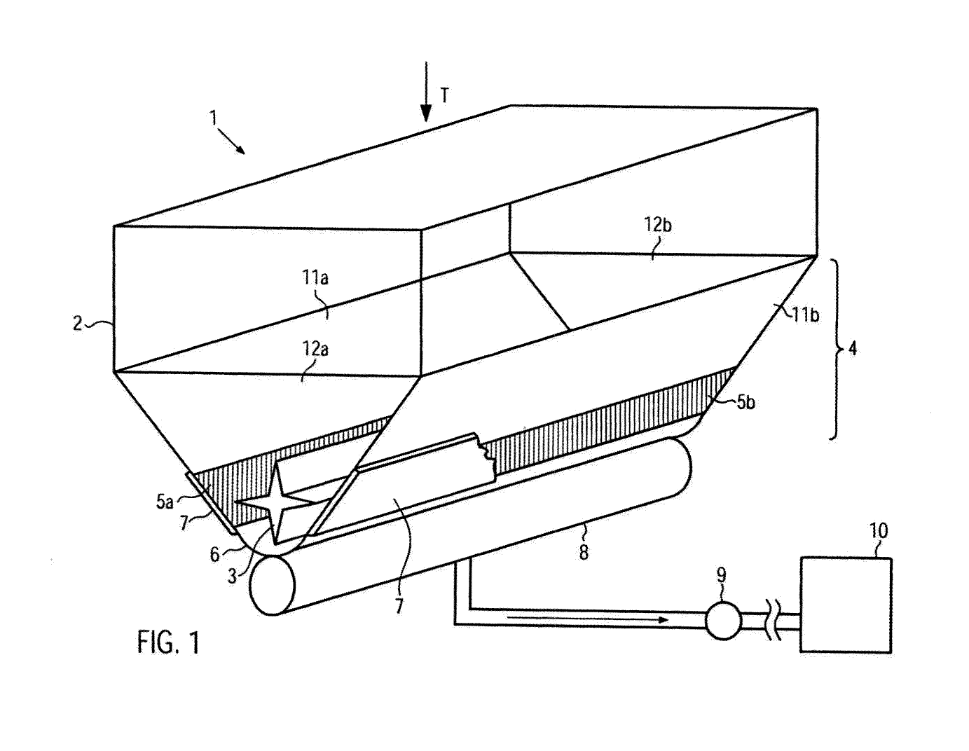

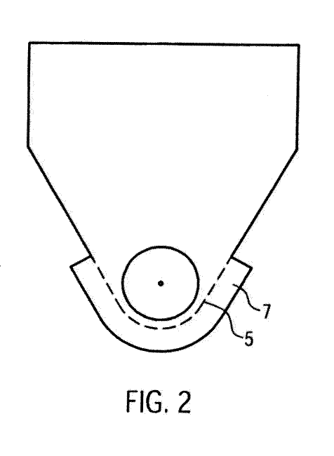

As can be taken from FIGS. 1 and 3, the spent grain bunker 1 according to the disclosure is embodied such that it can receive spent grain from the lauter tub 19 from above, as represented by the arrow T in FIG. 1. In this embodiment, the lower region 4 of the spent grain bunker has a funnel-like design, i.e. here the two side walls 11a, b extend towards each other. In this concrete embodiment, the front and rear walls 12a, b are arranged in parallel to each other. In the lower region of the housing 4, in this embodiment the side walls 11a, b are at least partially embodied as a strainer surface 5a, 5b. The strainer surface can be embodied as a punched plate or be made of one surface which is e.g. fabricated as the false bottom of a lauter tub, such as for example a slotted or milled false bottom or a wire kiln floor bottom. The sieve or mesh size of this strainer surface here corresponds to the above described mesh sizes and sieving areas of the false bottom 20, or particularly advantageously is 0.2-0.5 mm. The bottom 6 of the spent grain bunker is here embodied as a depression and preferably comprises several non-depicted openings, so that remaining fluid seeping through to the bottom can drain off or be withdrawn. As represented in FIG. 2, the bottom 6 can also be at least partially embodied as a strainer surface 5. The front and side wall can also be embodied as a strainer surface. Externally at the strainer surfaces, corresponding tubs 7 are arranged, so that withdrawn remaining water can be discharged between the tub wall and the strainer surface. In the process, for example, as represented in FIG. 3, several conduits 28 arranged along the side wall can be provided which guide remaining fluid from the tubs into an outlet pipe 8. In FIG. 1, for the two strainer surfaces 5a, 5b, one separate tub 7 each is provided. However, it is also possible to provide one mutual tub 7 for corresponding filter regions, as represented in FIG. 2. A pump 9 is provided in the drain conduit 8, so that the remaining fluid can be extracted from the spent grain via the strainer surfaces 5.

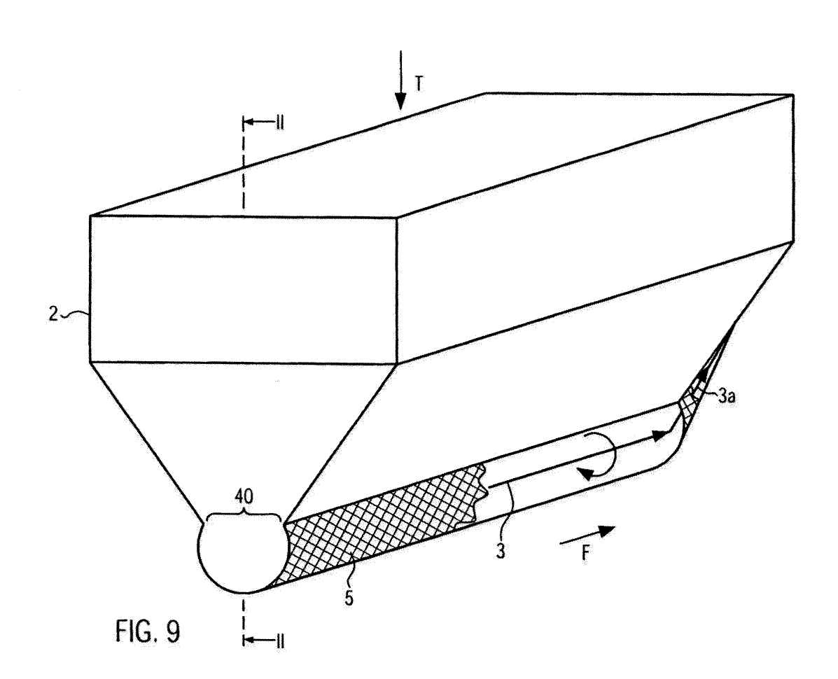

The delivery device can also be a pressing device, as will be illustrated more in detail in connection with the embodiment shown in FIGS. 9-11.

A delivery device 3 is provided in the lower region of the housing and delivers the spent grain out of the spent grain bunker. The delivery device 3 only schematically indicated in FIG. 1 can be, for example, a conveyor screw extending across the length of the spent grain bunker and being driven by a non-depicted motor. Advantageously, the delivery device is power or speed controlled and/or can be driven in alternating directions. Thus, the delivery device 3 can on the one hand be used to loosen up the spent grain during dewatering, where then the speed is only slow and possibly also the direction of rotation can be changed. If the spent grain is to be discharged, this can be done at a higher speed. The dewatered spent grain can be discharged from the spent grain bunker 1 into a spent grain silo.

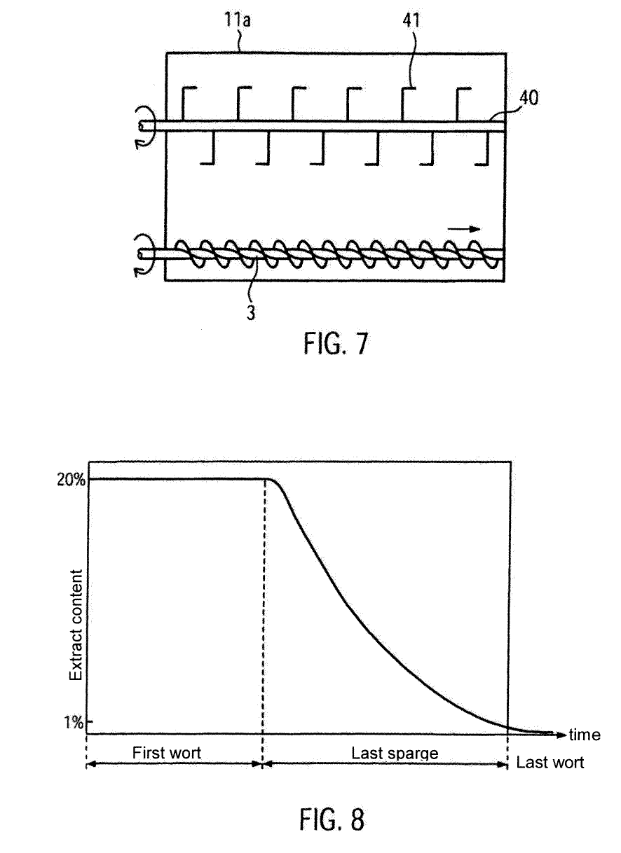

According to a preferred embodiment of the present disclosure, the spent grain bunker comprises, apart from the delivery device 3, a loosening device 40, as is represented in FIG. 7. The loosening device 40 is arranged above the delivery device 3. The loosening device 40 extends in the longitudinal direction of the spent grain bunker 1, as does the delivery device 3. The loosening device 40 comprises several radially extending loosening elements that can comprise hook sections to achieve a better loosening. As the delivery device 3, the loosening device 40 is speed controlled and/or can be driven in alternating directions. The loosening device 40 is in the process, as the delivery device, rotated by a drive not represented in FIG. 7, as shown by the arrows. The diameter of the loosening device 40, i.e. in FIG. 7 the height, is larger than the diameter of the delivery device 3, so that sufficient loosening in the spent grain bunker 1 can be achieved.

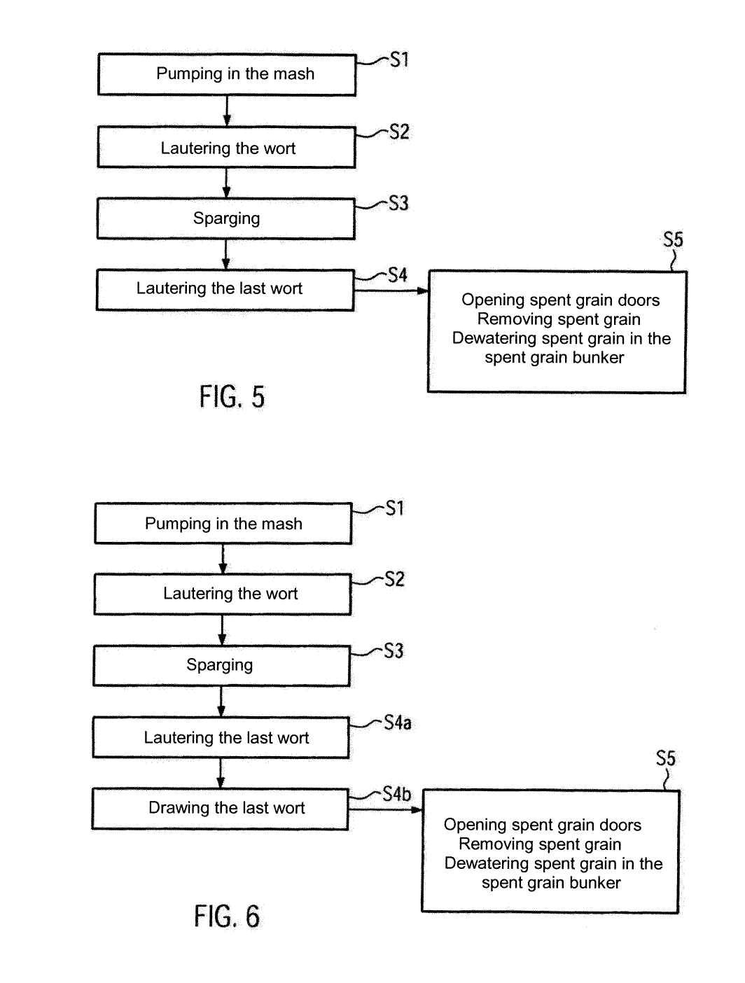

FIGS. 5 and 6 show possible embodiments of the method according to the disclosure.

In a known-manner, in the lautering process first the mash is supplied to the lauter tub, e.g. via the mash admission 35 (S1).

Finally, the first wort is first lautered (S2). The first wort is supplied to up/ort copper 30 (see FIG. 4) and/or a pre-run tank 34.

Subsequently, the last sparge is accomplished, where sparging water is introduced into the lauter tub 19 via the nozzles 26 (S3) and is also lautered (S4). The draining thinner worts are referred to as last sparges. During lautering, there is at least one last sparge. The sparging can also be performed several times, so that several last sparges are lautered.

According to the present disclosure, now the spent in is already removed while the last sparge 33 is draining by opening the spent grain door(s) 33 and pushing the spent grain into the spent grain bunker and dewatering it there as illustrated in connection with FIG. 1 (S5).

FIG. 8 shows an extraction curve from which one can take that the lautered first wort comprises a high extract content, where the last sparges comprise a lower extract content, and the last wort is drawn with a predetermined extract content and then no longer supplied to the pre-run vessel or to the wort copper. The corresponding extract content, however, depend on the type of beer to be brewed, so that FIG. 8 is only one example of a possible extraction curve. By the premature removal of the spent grain before the end of the last sparge, the lauter tub is ready for the next brew earlier. Due to the fact that the lautering of the last sparge in the lauter tub is prematurely stopped and the spent grain is supplied to the spent grain bunker 1, the spent grain bunker can assume a part of the function of the lauter tub 19.

That means, according to the present disclosure, the spent grain is removed into the spent grain bunker in a clearly moister state than before (for example with a water content of 80-90%). Without increasing the lauter time, then the spent grain can be extremely dewatered in the spent grain bunker and supplied to the spent grain silo in a very dry state.

While the last sparge is draining here means that the drawn off wort still has an extract range of more than 1-8%, preferably 2-6%, depending on the type of beer.

FIG. 6 shows another embodiment of the present disclosure. Here, too, the mash is first pumped in (S1) as described above, the first wort is lautered in a known manner (S2), sparged at least once (S3), and at least one last sparge is lautered (S4a), where then, when the last part of the last sparge that has been lautered comprises a very low extract content of about up to 1% or even higher, depending on the type of beer, the last wort is drawn (S4b) which is then no longer pumped into the pre-run tank or the wort copper, but e.g. into the last wort tank to be used for the subsequent brew, for example as mashing water, or added to the sparging water.

In this embodiment, the spent grain door 33 is opened while the last wort is being lautered, and the moist spent grain is pushed into the spent grain bunker 1. In the spent grain bunker 1, the spent grain is then further dewatered.

As becomes clear in particular in connection with FIG. 8, according to the second embodiment, the procedure of the drawing of the last wort in the lauter tub 19 can be prematurely stopped, the last wort then being further drawn in the spent grain bunker 1. By the premature removal of the spent grain before the end of the drawing of the final wort, the lauter tub is ready for the next brew earlier.

That means, the spent grain bunker according to the present disclosure assumes a part of the last wort lautering process and/or a part of the drawing of the last wort.

In the spent grain bunker, the moist spent grain is then further dewatered as described above.

FIG. 4 roughly schematically shows the mash container 29 from which the mash is guided into the lauter tub 19 (see arrow P1). The lautered first wort as well as the lautered last sparges are forwarded from the lauter tub 19 either directly into the wort copper 30 (see arrows P3, P4, 99) or else they are first guided to the pre-run vessel 34 (P3, P5) from which the wort can be forwarded to the wort copper 30 (P8, P9). As described above, the remaining fluid that is extracted from the spent grain in the spent grain bunker 1 can be also supplied to the wort copper 30 in the method shown in FIG. 5 (P2, P7), or it can be supplied to the wort copper 30 (P2, P6, P8, P9) via the pre-run vessel 34 (P2, P6). If the extract content of the remaining fluid that is extracted from the spent grain in the spent grain bunker is below a limit that depends on the type of beer (e.g. from 0.8 to 1 or ˜≧1%), this remaining fluid is then no longer supplied to the wort copper but e.g. to a last wort tank 36 (P2, P10).

In the method described in connection with FIG. 6, the last wort is also supplied from the spent grain bunker 1 e.g. to the last wort tank 36 (see arrows P2, P10). FIG. 4 is only a roughly schematic representation that does not show the corresponding required valves and pumps.

FIG. 9 shows, in a perspective representation, another embodiment according to the present disclosure. This embodiment essentially corresponds to the embodiments above, however, here the delivery device 3 is formed by a pressure worm which extracts the remaining fluid from the spent grain by pressing.

As can be taken in particular from FIGS. 9 to 11, here the strainer surface 5 is embodied as essentially tubularly bent strainer basket. As can be taken from FIG. 9, the strainer basket is connected to the side walls of the housing 2, here with the tapered side walls in the lower region. The strainer basket here e.g. has a cross-section like a divided circle. The strainer surface is embodied corresponding to the strainer surfaces as described in the previous embodiments. The strainer basket extends in the bottom region of the housing 2 of the spent grain bunker 1 advantageously at least across the total length of the spent grain bunker 1. At its upper side, the strainer basket comprises an opening 40 extending advantageously across the total length. Via the opening 40, spent grain can fall into the strainer basket 5.

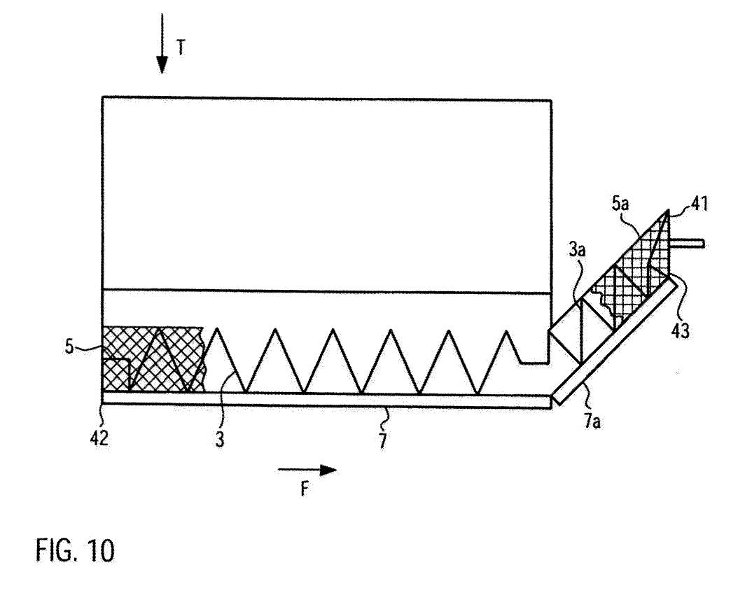

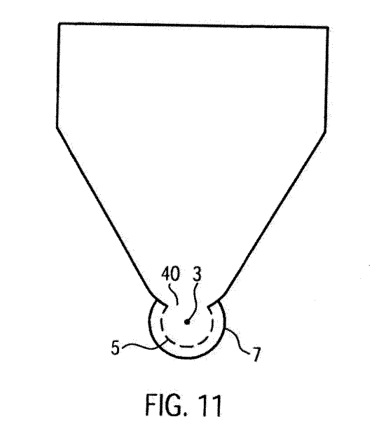

In the center of the strainer basket, the delivery device 3, here the pressure worm, extends axially. The pressure worm here has two functions. On the one hand, it conveys the pressed out spent grain in the direction of the arrow F out of the spent grain bunker, furthermore it presses the remaining fluid out of the spent grains which can then drain through the strainer basket. The pressure worm could end in the end region of the spent grain bunker and discharge the spent grains there. As is shown in FIG. 10, this embodiment comprises a pressure worm comprising a first section in the lower region of the housing 2 followed by a second section 3a which is arranged laterally of the housing, preferably extending diagonally towards the top. In this region, the strainer basket 5a can be closed around the pressure worm 3a. For collecting the press water, underneath the strainer basket 5 or underneath the strainer basket 5a, a drip channel 7 can be provided, each having a slope. The slope of the drip channel underneath the pressure worm 3 is for example 1%, so that the remaining fluid can drain via the outlet 42. The drip channel 7a can either be connected to the drip channel 7, or it can remove the remaining fluid separately. As can be taken from FIG. 11, as an alternative to a channel arranged underneath the strainer basket, corresponding to the above embodiments (see FIG. 2), a closed housing can be arranged around the strainer basket 5.

The pressure worm 3 is speed or frequency controlled, so that the performance can be adapted. To generate a pressing power, for example a pressure worm can be used, of which the diameter increases in the direction F or towards its end region, such as a conical pressure worm. As an alternative or in addition, and as can be taken in particular from FIG. 10, a resistance 41, here a press cone, can be attached at the end of the pressure worm 3, 3a, which determines the pressing power onto the spent grain. The resistance can be pneumatically controlled so that the pressing power can be adjusted via the position of the resistance element, here the cone 41, as well as depending on the speed of the pressure worm. The further the resistance element closes the outlet region 43, and the higher the speed is, the higher is the pressing power in the pressure worm 3. Thus, in the method according to the disclosure, the spent grain in the worm 3, 3a can first be dewatered at a high pressing power and then be discharged via the delivery device 3 and the outlet 43, and subsequently be supplied for example to a spent grain silo via a non-depicted transport device. The method of this embodiment corresponds to the above shown method, where the remaining fluid from the outlet 42 is forwarded as illustrated in connection with FIG. 4.

By means of the present disclosure, the last sparge or the last wort, which had been up to now completely drawn in the lauter tub, now can be at least partially drawn in the spent grain bunker 1, so that the lauter time altogether is shortened resulting in greater brew cycles. Moreover, without the lauter time in the lauter tub being increased, the spent in can be dried more effectively.

The embodiments have been described in connection with a lauter tub. Basically, however, instead of the lauter tub other lauter devices can be used for separating the spent grain (in particular by means of a strainer surface) where lautering is prematurely stopped as described and continued in the spent grain bunker.

According to the present disclosure, the spent grain can be removed prematurely, the water content here being, for example, still 80 to 90%. In the spent grain bunker, the water content can then be reduced to about 70 to 60%.

1. Spent grain bunker for receiving spent grain from a lauter device, in particular from a lauter tub, comprising a housing and a delivery device arranged in a lower region of the housing and transporting the spent grain from the spent grain bunker, and in the lower region of the housing, at least one part of the housing is embodied as a strainer surface.

2. Spent grain bunker according to claim 1, wherein the housing is embodied essentially like a funnel at least in the lower region.

3. Spent grain bunker according to claim 1, wherein one of at least one part of the side walls of the housing, at least one part of the front and rear walls, or a combination thereof are embodied as a strainer surface.

4. Spent grain bunker according to claim 1, wherein the housing comprises a bottom which comprises several openings or is at least partially embodied as a strainer surface.

5. Spent grain bunker according to 1, wherein one of externally at the strainer surface, a tub is arranged via which remaining fluid can be extracted from the spent grain, or a channel is arranged underneath the strainer surface via which the remaining fluid drains.

6. Spent grain bunker according to claim 1, wherein in that in the housing several strainer surfaces are arranged which comprise one of corresponding tubs or one mutual tub.

7. Spent grain bunker according to claim 1, wherein the delivery device is one of speed controlled, can be driven in alternating directions, or a combination thereof.

8. Spent grain bunker according to claims 1, and a loosening device is arranged above the delivery device.

9. Spent grain bunker according to claim 1, wherein the delivery device is a pressure worm that presses the remaining fluid out of the spent grain.

10. Spent grain bunker according to claim 9, wherein the strainer surface is arranged as tubular strainer basket at the bottom of the housing and comprises an opening directed towards the top, where the pressure worm runs in the tubular strainer basket.

11. Spent grain bunker according to claim 9, wherein the pressure worm comprises a first section arranged in the lower region of the housing, and a second section extending laterally from the housing.

12. Lautering process for producing wort by means of a lauter device, in particular by means of a lauter tub, where mash is introduced into the lauter device, the first wort and then at least one last sparge is lautered, comprising during one of the draining of the last sparge or during the drawing of the last wort, removing the spent grain is from the lauter device into a spent grain bunker, and in the spent grain bunker extracting remaining fluid from the spent grain via a strainer surface.

13. Lautering process according to claim 12, and supplying the remaining fluid extracted in the spent grain bunker to a tank.

14. Method according to claim 12, and using the remaining fluid extracted in the spent grain bunker for the next brew.

15. Method according to claim 12, and discharging the compacted spent grain, after remaining fluid has been withdrawn from it, from the spent grain bunker via a delivery device.

16. Method according to claim 15, wherein the delivery device is a pressure worm that presses remaining fluid out of the spent grain.

17. Lauter device, in particular lauter tub for lautering wort, comprising at least one spent grain bunker according to claim 1.

18. Spent grain bunker according to claim 11, wherein the section extends from the housing diagonally towards the top.

19. Lautering process according to claim 13, wherein the tank is one of a last wort tank, a pre-run vessel, and a wort copper.

20. Method according to claim 16, wherein the pressing power of the pressure worm is controllable.
